(19) United States
(12) Patent Application Publication
(10) Pub. No.: US 2026/0170101 A1
(43) Pub. Date: Jun. 18, 2026

(54) AUTOMATED SUPPORT TO THREAT MODELING VIA ARTIFICIAL INTELLIGENCE

(71) Applicant: SAP SE, Walldorf (DE)

(72) Inventors: Antonino Sabetta, Mouans Sartoux (FR); Michele Bezzi, Le Haut Sertoux Valbonne (FR)

(21) Appl. No.: 18/984,517

(22) Filed: Dec. 17, 2024

(51) Int. Cl. G06F 21/12; G06F 21/55

(52) U.S. Cl. CPC G06F 21/12; G06F 21/552

(57) ABSTRACT

The disclosure generally describes methods, software, and systems for generation of attack vectors and threat modeling using artificial intelligence models. A request to perform threat modeling for a software system including nodes performing operations vulnerable to threats is received. Tokens that include pairs of nodes and one or more edges are generated. A set of paths corresponding to a known threat applicable to a portion of the nodes of a respective path is generated, using the tokens. A similarity search for the set of paths is performed, to determine similar paths corresponding to known threats and known mitigations. A prompt for a prediction model is generated, using the similar path, the known threats, and the known mitigations. A list of threats and a mitigation plan to modify the software system to mitigate the threats is received, from the prediction model.

### TECHNICAL FIELD

The present disclosure relates to development of lifecycle security. More particularly, implementations of the present disclosure are directed to generation of attack vectors and threat modeling using artificial intelligence (AI) as a tool.

### BACKGROUND

Threat modeling is essential for identification and mitigation of potential security risks throughout a secure development lifecycle. The representation of different system components and their interactions can highlight potential vulnerabilities and how they could be exploited. Most modern systems are highly complex, with numerous components and interactions that change over time. Accurately mapping the components complex computing systems and their roles relative to their changes over time requires a sustained an ongoing effort, such that keeping the threat models up to date with continuous deployment and changing environments can be demanding. Various tools that are available for threat modeling have limitations in terms of scalability, ease of use, and integration with other security tools, sometimes generating incompatibilities between coordination of development, security, and operations teams. The described tool limitations make integration of threat modeling into the secure development lifecycle a time-consuming and resource intensive process, especially for complex computing systems.

### SUMMARY

Implementations of the present disclosure are directed to techniques and tools for development of lifecycle security. More particularly, implementations of the present disclosure are directed to generation of attack vectors and threat modeling using artificial intelligence (AI) as a tool.

In some implementations, a method includes: receiving a request to perform threat modeling for a software system including nodes performing operations vulnerable to threats, generating tokens that include pairs of nodes and one or more edges, wherein the one or more edges define operations between nodes of the pairs of nodes, generating, using the tokens, a set of paths, wherein each path in the set of paths corresponds to a known threat applicable to a portion of the nodes of a respective path, performing a similarity search for the set of paths, to determine a similar path to one path of the set of path, the one path including at least a difference from the similar path, the similar path corresponding to known threats and known mitigations, generating, using the one path, the known threats, and the known mitigations, a prompt for a prediction model, and receiving, from the prediction model, a list of threats and a mitigation plan to modify the software system to mitigate the threats.

The foregoing and other implementations can each optionally include one or more of the following features, alone or in combination. In particular, implementations can include all of the following features:

In some aspects, combinable with any of the previous aspects, the prediction model includes a trained large language model. The trained large language model is trained using a plurality of mitigated threats mapped to node settings. Generating, using the tokens, a set of paths, includes reducing the set of paths to remove a portion of the set of paths, and generating a reduced set of paths. Reducing the set of paths to remove a portion of the set of paths, includes removal of sub-paths, removal of paths in the set of paths that are shorter than a threshold path length, and limiting a path length. Generating, using the tokens, a set of paths, includes within each path of the set of paths, selecting each token at most once, and determining that all tokens of each path of the set of paths are connected. Generating, using the set of paths, a prompt for a prediction model, includes retrieving a prompt template prefixed with a textual content of documents. Generating a graphical representation of the list of threats and mitigations.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described implementation provides an efficient automatic threat scenario generation and optimization of security measures. The generative AI can analyze the abstract description of a computing system and can automatically generate potential threat scenarios. The described implementation reduces the risk of error introduction in threat identification and ensures a comprehensive and accurate identification of threats. As an advantage, the described implementations provide an enhanced threat modeling accuracy and consistency. The described implementations provide generation of sets of paths corresponding to threats applicable to computing system nodes that facilitate the trained AI models to predict and identify patterns indicative of cyber threats with increased precision. The described enhanced implementations provide prediction model prompts, derived from the set of paths according to a set of rules that optimizes usage of system resources. As another advantage, the described implementations, including path generation for prediction model prompts, leading to risk mitigation identification, significantly streamline the threat modeling processes reducing the threat modeling time and facilitating automatic implementation of security measures.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for generation of attack vectors and threat modeling, according to some implementations of the present disclosure.

FIG. 2 is a block diagram of an example system architecture for generation of attack vectors and threat modeling, according to some implementations of the present disclosure.

FIG. 3A is a block diagram of an example data flow model of an example system, according to some implementations of the present disclosure.

FIG. 3B is a block diagram of an example data flow model including tokens, according to some implementations of the present disclosure.

FIG. 4 is a flowchart of an example process for generation of attack vectors and threat modeling, according to some implementations of the present disclosure.

FIG. 5 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to modeling threats for development of lifecycle security. More particularly, implementations of the present disclosure are directed to generation of attack vectors and threat modeling using artificial intelligence (AI) as a tool for threat modeling. Threat modeling is a structured methodology used to identify system vulnerabilities, to recognize potential threats and to define corresponding mitigation strategies to protect the respective system. The target system can be a software system that includes multiple subsystems, each subsystem includes nodes, such as system components including user devices, data bases, memories or other computing components. The nodes contain data and links to other nodes within the respective subsystem or other subsystems of the target system. The threat modeling process includes identification and risk assessment of the nodes, as protectable assets of the software system. The nodes can be used to define a representation of the respective target system, as a data flow model. Each of the nodes can present risks and vulnerabilities that can be analyzed to identify potential threats and a list of mitigation strategies to address the identified threats. The risk assessment process can be performed during the design of the software system, with the scope of addressing weaknesses before a threat actor can exploit them.

Some traditional threat modeling protocols can include errors related to incorrect or unoptimized identification of potential threats due to incomplete or inefficient analysis of software system risks and vulnerabilities. The limitations of traditional threat modeling protocols are attributed to the dependence on expertise of analyzing risks and vulnerabilities of software systems, which can be costly and time consuming. Other limitations of traditional threat modeling protocols stem from a disproportion between available resources and requests for rapid delivery times characterizing modern software systems.

Addressing the limitations of traditional threat modeling protocols, the automatic threat modeling described in the present disclosure leads to an increase in the accuracy of potential threats based on an optimized analysis of risks and vulnerabilities of software systems. The described approach combines generative AI to support threat modeling activities by automatically proposing threat scenarios for a particular software system, whose abstract description is provided as a data flow model. The data flow model is analyzed to extract data flow model fragments defining paths, represented as attack vectors. Each attack vector is related to a textual description of threats and mitigations stored in textual format. The paths are processed to generate queries for a pre-existing database of threats and mitigations associated with respective data flow model fragments defining path represented as attack vectors. The described approach also generates a prompt from the results of the queries that is provided to a prediction model. In the described solution, the prediction model can be trained to process the prompt to obtain verifiable threat scenarios. The generated threat scenarios are associated with a particular fragment of the input model, that can be annotated with the generated threats. The described solution overcomes potential challenges in optimizing generation of attack vectors as paths corresponding to a threat applicable to the software system nodes, ensuring efficient and contextually relevant system threat identification. The approach broadens the scope of prediction models (e.g., generative AI) by advantageously addressing considerations regarding optimization, accuracy, and adaptability in handling diverse system configurations for threat modeling. As another advantage, the described approach democratizes threat modeling improving the overall security of complex systems.

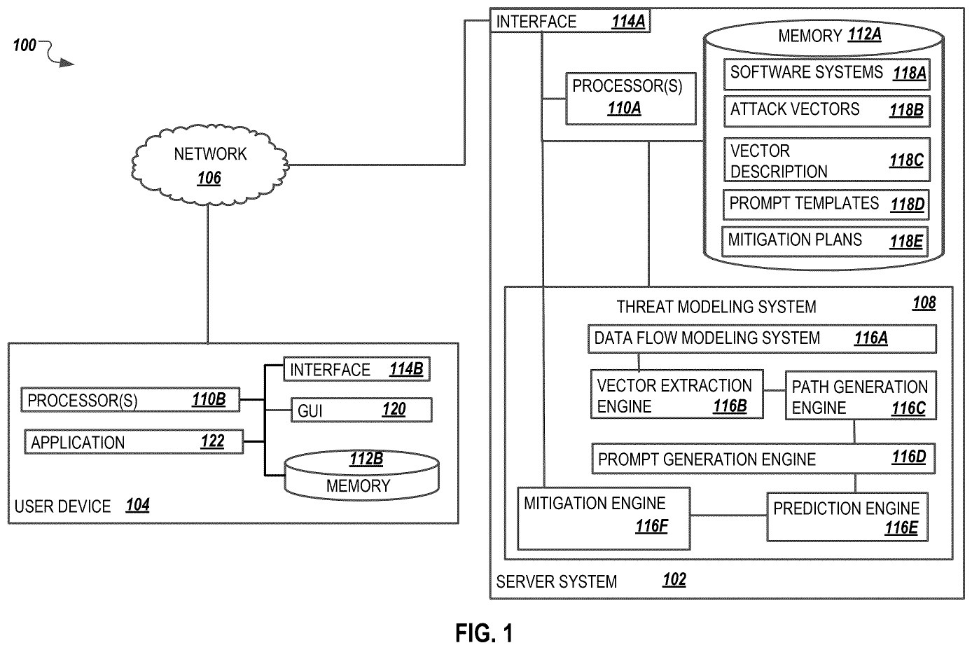

FIG. 1 is a block diagram of an example system 100 for generation of attack vectors and threat modeling, according to some implementations of the present disclosure. Specifically, the illustrated example system 100 includes or is communicably coupled with a server system 102, a user device 104, and a network 106. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool. In general, server systems 102 accept requests for application services including threat modeling services and provides such services to any number of user devices 104 (e.g., the user device 104 over the network 106). In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes associated with threat modeling, including implementation of mitigation plans. For example, the server system 102 includes a threat modeling system 108, a processor 110A, a memory 112A, and an interface 114A.

The threat modeling system 108 can include a data flow modeling system 116A, a vector extraction engine 116B, a path generation engine 116C, a prompt generation engine 116D, a prediction engine 116E, and a mitigation engine 116F. The threat modeling system 108 is coupled to the processor 110A, the memory 112A, and the interface 114A for generation of attack vectors and threat modeling using data stored in the memory 112A. The memory 112A can include software systems 118A, attack vectors 118B, vector descriptions 118C, prompt templates 118D, and mitigation plans 118E.

For example, user devices 104 can generate requests to access a software system 118A (e.g., through a webpage). The threat modeling system 108 can be used to generate data flow models for the software system 118A, using the data flow modeling system 116A. The data flow modeling system 116A can transmit the generated data flow model to the vector extraction engine 116B. The vector extraction engine 116B can extract attack vectors 118B from fragments of the data flow model and send the attack vectors 118B to the path generation engine 116C and to the memory 112A for storage. The path generation engine 116C can process the attack vectors 118B, according to a set of rules, to generate an optimized path. The path generation engine 116C can transmit the path to the prompt generation engine 116D to generate, using the vector descriptions 118C and a prompt template 118D, a prompt for the prediction engine 116E. The prediction engine 116E can use a prediction model to produce textual descriptions of threats and mitigations associated with the path corresponding to the prompt and send them to the mitigation engine 116F. The mitigation engine 116F can process the textual descriptions of threats and mitigations to generate a mitigation plan that can be displayed on the GUI 120 and stored in the memory 112A.

The components of the threat modeling system 108, including the prompt generation engine 116D, the prediction engine 116E, and the mitigation engine 116F can include machine learning (e.g., generative AI) functionality for optimizing generation of attack vectors 118B and threat modeling. For example, the prompt generation engine 116D of the present disclosure is coupled to the interface 114A to provide an integrated UI rendering solution within a digital assistant that leverages generative AI to infer a context of the software system 118A and optimize prompt processing for generation of an efficient mitigation plan that effectively increases a security of the software system 118A. More particularly, the threat modeling system 108 of the present disclosure calls the prompt generation engine 116D to leverage the ability of the prediction engines 116E including large language models (LLM) to generate descriptions of threats and mitigations and to automatically create a mitigation solution applicable to the target software system 118A and context.

In general, the user device 104 includes an electronic computer device operable to receive, transmit, process, and store any appropriate data associated with the system 100 of FIG. 1. The user device 104 is generally intended to encompass any client computing device such as a laptop/notebook computer, wireless data port, smart phone, personal data assistant (PDA), tablet computing device, one or more processors within these devices, or any other suitable processing device. The user device 104 includes an interface 114B, a processor 110B, a memory 112B, and a graphical user interface (GUIs) 120. The user device 104 can include one or more applications 122. The application 122 can be any type of application that allows a user device to request and view content on the user device (e.g., generate a request for threat modeling). In some implementations, an application 122 can use parameters, metadata, and other data to access the threat modeling system 108 from the server system 102. In some instances, an application 122 can be an agent or client-side version of the one or more enterprise applications running on an enterprise server (not shown).

In accordance with implementations of the present disclosure, the application 122 includes a digital assistant that enables interactions with the user device 104. For example, and as described in further detail herein, the digital assistant of the user device 104 can receive a query. In some examples, one or more query responses can include data that is presented as a graphical representation in the GUI 120. In accordance with implementations of the present disclosure, the digital assistant can present data as a graphical representation in a popover container within a window therein. In some examples, the popover container is provided as an iframe-based container and the digital assistant communicates with the popover container using remote procedure calls.

As described in further detail herein, a user can input a query to the digital assistant and the digital assistant can receive a response to the query. In accordance with implementations of the present disclosure, the response can include a display of a mitigation plan 118E. In some examples, the response can include a graphical representation of the data flow model with annotations including threats identified by the prediction engine 116E (e.g., LLM) in view of the context of the software system and is displayed in a UI of the digital assistant. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAPUI5 provided by SAP SE of Walldorf, Germany.

In some implementations, any or all of the components of the example system 100, both hardware or software (or a combination of hardware and software), may interface with each other or the interface(s) 114A, 114B, (or a combination of both) over the network 106 for threat modeling. The functionality of the user device 104 can be accessible for all service consumers using the application 122 that transmits prompts to the threat modeling system 108 to generate mitigation plans 118E.

For example, the user device 104 may include a computer that includes an input device, such as a keypad, touch screen, or other device that can accept user information, and an output device that conveys information associated with the operation of the server system 102, or the user device itself, including digital data, visual information, or a GUI 120, respectively. The GUI 120 each interface with at least a portion of the system 100 for any suitable purpose, including generating a visual representation of the application 122 or the administrative application 133, respectively. In particular, the GUI 120 can be used to view and navigate various Web pages. The GUI 120 can provide the user with an efficient and user-friendly presentation of business data provided by or communicated within the system. The GUI 120 can include a plurality of customizable frames or views having interactive fields, pull-down lists, and buttons operated by the user. The GUI 120 can include any suitable graphical user interface, such as a combination of a generic web browser, intelligent engine, and command line interface (CLI) that processes information and efficiently presents the results to the user visually.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 106, is transferred using any number of network layer protocols, such as Internet Protocol (IP), Multiprotocol Label Switching (MPLS), Asynchronous Transfer Mode (ATM), Frame Relay, etc. Furthermore, in implementations where the network 106 represents a combination of multiple sub-networks, different network layer protocols are used at each of the underlying sub-networks. In some implementations, the network 106 represents one or more interconnected internetworks, such as the public Internet.

Each processor 110A, 110B included in the user device 104 can be a central processing unit (CPU), an application specific integrated circuit (ASIC), a field-programmable gate array (FPGA), or another suitable component. Each processor 110A, 110B included in the user device 104 executes instructions and manipulates data to perform the operations of the user device 104, respectively. Specifically, each processor 110A, 110B included in the user device 104 executes the functionality required to send requests to the server system 102 and to receive and process responses from the server system 102. Each processor 110A, 110B can be a CPU, a blade, an ASIC, a FPGA, or another suitable component. Each processor 110A, 110B executes instructions and manipulates data to perform the operations of the respective system (the server system 102, the user device 104). Specifically, each processor 110A, 110B executes the functionality required to receive and respond to requests from the respective system (the server system 102, the user device 104), for example.

Interfaces 114A, 114B are used by the server system 102, the user device 104, respectively, for communicating with other systems in a distributed environment - including within the system 100 - connected to the network 106. Generally, the interfaces 114A, 114B each include logic encoded in software and/or hardware in a suitable combination and operable to communicate with the network 106. More specifically, the interfaces 114A, 114B may each include software supporting one or more communication protocols associated with communications such that the network 106 or interface's hardware is operable to communicate physical signals within and outside of the illustrated system 100.

The memory 112A, 112B may include any type of memory or database module and may take the form of volatile and/or non-volatile memory including, without limitation, magnetic media, optical media, random access memory (RAM), read-only memory (ROM), removable media, or any other suitable local or remote memory component. The memory 112A, 112B may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, or the user device 104, respectively.

There can be any number of user devices 104 and API provider systems 110 associated with, or external to, the system 100. Additionally, the example system 100 can include one or more additional user devices external to the illustrated portion of system 100 that are capable of interacting with the system 100 via the network(s) 106. Further, the term “client,” “user device,” and “user” can be used interchangeably as appropriate without departing from the scope of the disclosure. Moreover, while user device can be described in terms of being used by a single user, the disclosure contemplates that many users may use one computer, or that one user may use multiple computers. As used in the present disclosure, the term “computer” is intended to encompass any suitable processing device. For example, although FIG. 1 illustrates a single server system 102, a single user device 104, the system 100 can be implemented using a single, stand-alone computing device, two or more servers 102, or multiple user devices. The server system 102, and the user device 104 may include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the user device 104 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 may also include or be communicably coupled with an e-mail server, a Web server, a caching server, a streaming data server, and/or another suitable server.

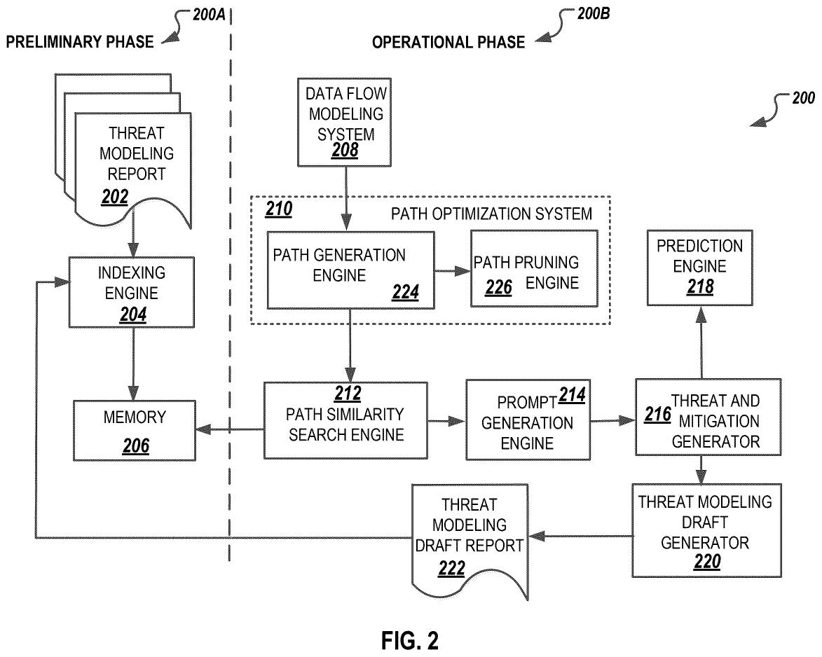

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP (Advanced Business Application Programming), ABAP OO (Object Oriented), any suitable version of 4GL, as well as others. While portions of the software illustrated in FIG. 1 are shown as individual modules that implement the various features and functionality through various objects, methods, or other processes, the software may instead include multiple sub-modules, third-party services, components, libraries, and such, as appropriate. Conversely, the features and functionality of various components can be combined into single components as appropriate. The communication between the user device 104 and the server system 102 can include several different communication protocols configured to optimize generation of attack vectors 118B and threat modeling, as further described in detail with reference to FIGS. 2-5.

FIG. 2 is a block diagram of an example system architecture 200 for generation of attack vectors and threat modeling, according to some implementations of the present disclosure. The example system architecture 200 includes a preliminary phase portion 200A and an operational phase portion 200B. The preliminary phase portion 200A includes a threat modeling reports 202, an indexing engine 204, and a memory 206 (e.g., memory 112A described with reference to FIG. 1). The operational phase portion 200B includes a data flow modeling system 208 (e.g., data flow modeling system 116A described with reference to FIG. 1), a path optimization system 210, a path similarity search engine 212, a prompt generation engine 214 (e.g., prompt generation engine 116D described with reference to FIG. 1), a threat and mitigation generator 216, a prediction engine 218 (e.g., prediction engine 116E described with reference to FIG. 1), a threat modeling draft generator 220, and a threat modeling draft reports 222. The path optimization system 210 includes a path generation engine 224 and a path pruning engine 226.

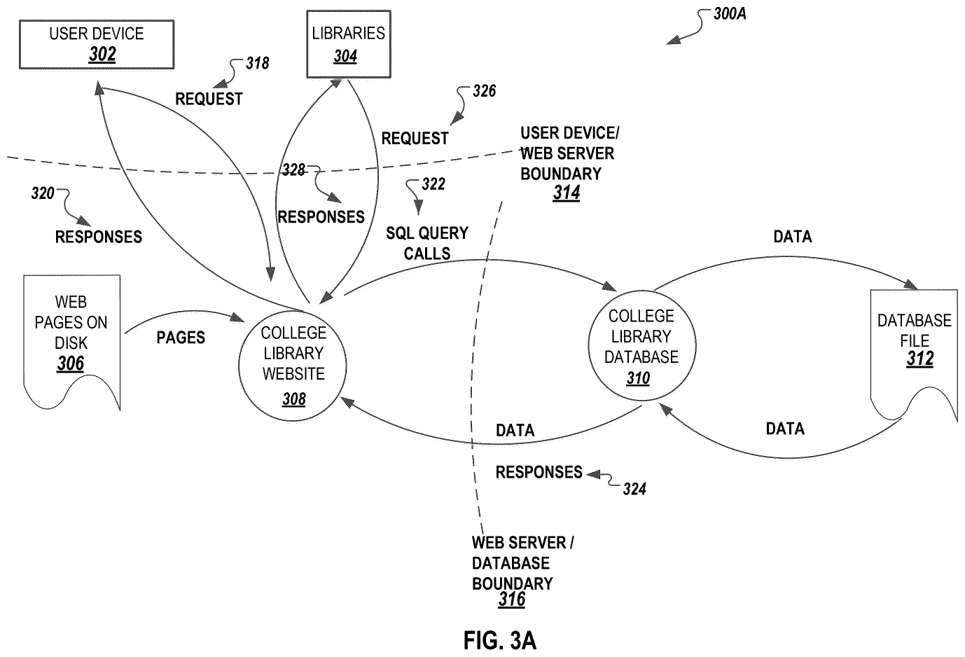

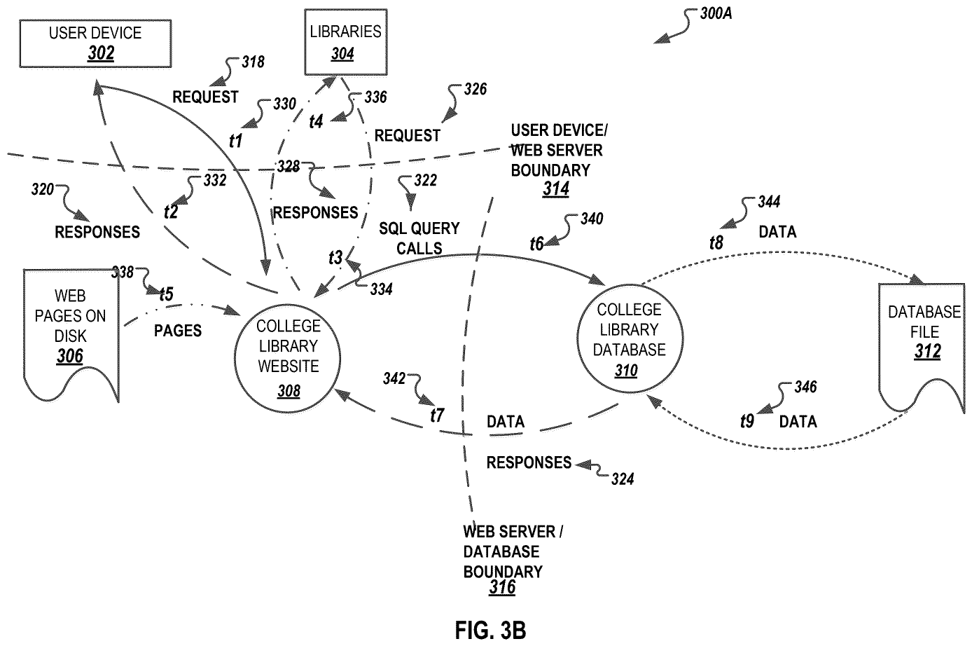

The memory 206 can be a vector database developed during the preliminary phase of threat modeling implementations, using the preliminary phase portion 200A. The memory 206 can include a collection of threat modeling reports 202. The threat modeling reports 202 can be validated past reports generated in response to threat analyses or artificially generated reports. For example, threat modeling draft reports 222 generated by the threat modeling draft reports 222 can be stored in the memory 206 as threat modeling reports 202. The data in the threat modeling reports 202 can be stored, by the memory 206, as vectors that are indexed, using the indexing engine 204. The vectors can be extracted from data flow models obtained from respective threat modeling documents. During vector extraction, for each threat listed in the threat modeling document, the path included in the data flow model that is impacted by the threat is determined. A vector for the identified path is generated and stored. The vector can be stored together with the corresponding textual descriptions of threats and mitigations. In some implementations, the memory 206 is built using a collection of data flow models extracted from documents describing the outcome of past threat modeling analyses. Each document stored in the memory 206 can include three parts: a data flow diagram or its machine-readable counterpart (e.g., graphs as shown in FIGS. 3A and 3B), and sections on threats and mitigations (e.g., textual descriptions).

With continued reference to the preliminary phase, the ordered pairs of nodes in the data flow model that are adjacent (e.g., that are connected directly by an edge in the graph) are enumerated. The data flow model can be a directed graph (e.g., the edges are “arrows” with a direction), facilitating tracking of the order of the two nodes that are connected by a particular arrow. The labels on the directed edge, and edge crossing with a trust boundary are also tracked. The pairs of nodes (n₁, n₂) and the connecting edge can be a “token” of the data flow model, defined as triple (n₁, e, n₂). All the possible ways in which the tokens can be built in the previous step can be combined to form paths can be enumerated. For example, two tokens t₁=(n_{b}, e₁, nₑ) and t₂=(m_{b}, e₂, mₑ) can be combined if they have a common node nₑ=m_{b}. Applying the common node combination rule, facilitates construction of the path P corresponding to the threat Th. The constructed path corresponding to the threat can be vectorized to generate the vector (P, Th, M) that can be indexed using the key P. The indexing of the stored vectors facilitate retrieval during an operation phase, by searching for P. The search can be performed by path similarity, wherein a path P₁ that is similar to a previously stored path P stored in the memory 206, facilitate the retrieval of the previously stored path P and the corresponding threat Th and mitigation M. The corresponding threats Th and mitigations M related to paths are stored in the memory 206, in a textual format. The memory 206 can store vectors for multiple software systems. For each software system, multiple vectors can be obtained, such that each threat described in the threat modeling document can be considered.

During an operation phase, the data flow modeling system 208 receives requests from a user device, to perform threat modeling of a software system that can be a new software system or a recently updated software system transitioning from a first phase of a life cycle to a second phase of the life cycle. The data flow modeling system 208 can identify nodes, as protectable assets of the software system. The data flow modeling system 208 can generate, using a threat modeling document, retrieved from the memory 206, a data flow model representing the nodes, as components of the software system, and connections between the nodes. The connections between the nodes can be used to define data flows (e.g., data requests and responses to data requests) between the nodes. The data flow model can be a machine-readable representation of the data flow diagram. The data flow modeling system 208 can transmit the data flow model to the path optimization system 210 that retrieves, by using path similarity, relevant data (e.g., threat Th and mitigation M) from the memory 206 to generate and optimize paths corresponding to a threat applicable to nodes of the software system.

For example, the path generation engine 224 of the path optimization system 210 can extract fragments (e.g., paths) from the data flow model and represent the extracted fragments as vectors. The path generation engine 224 can combine the tokens of the extracted fragments to generate a set of tokens TS_{P}={TSₜᵢ} (i=1 . . . n) of all paths. The path generation engine 224 can generate the set of tokens using two rules: 1) each token to be selected and used at most once for a particular path and 2) all tokens of the path to be connected through a single chain of nodes without creating multiple chains of connected tokens. The combinatorial nature of node chain generation can lead to an extremely large set of paths that can be reduced before path processing to generate the prompt.

In some implementations, the path generation engine 224 builds a set of meaningful paths that is reduced-by-construction. The reduction by construction can be implemented using a process that initializes the path generation by defining K as a constant representing the maximum path length, by defining T as a set containing all tokens, and by defining R to be the same as T, representing the remaining tokens to be processed. The reduction by construction can include a main loop, such as a while loop that runs as long as R is not empty. Inside the loop, a new empty list path is created to store the current path. A random token is selected from R and added to path. The variable i is initialized to 1 to keep track of the path length. The reduction by construction can include a path generation as a nested while loop that runs until a counter i exceeds K (the maximum path length). Inside the path generation loop, the next token is determined by the neighbourₜₒₖₑₙ function, which finds a neighboring token of the current token within R. If no neighboring token is found (nextₜₒₖₑₙ is null or None), the loop can end. Otherwise, the next token is removed from R, added to path, and the current token is updated to the next token. After exiting the nested loop, of the reduction by construction the path can be stored in the memory 206, such that the generated path is added to the set P.

In some implementations, the path generation engine 224 transmits the set of all paths to the path pruning engine 226 to prune the set. The path pruning engine 226 can select a smaller subset out of possible paths, according to one or more selection strategies, such as: 1) if a path is a sub-path of another, delete it; 2) delete all paths that are shorter than a particular threshold (e.g., the threshold can be set to the median length of all paths); and 3) apply diameter filtering for each node, following the directed edges, construct the path of maximal length and starting from it and with no repeating nodes and if a path is a sub-path of another, delete it.

The path optimization system 210 can transmits the pruned and/or optimized set of paths to the path similarity search engine 212. The path similarity search engine 212 can perform a vector search in the memory 206 using the optimized or the pruned path. For each received path, the path optimization system 210 can query the memory 206, to perform a similarity search and to retrieve similar paths. The memory 206 can send the results to the query as a set of triples (path, threat, mitigation), to the path similarity search engine 212. For each path, the results can include threats and mitigations corresponding to paths that are similar to those of the TS_{DFM}. Similar paths indicate identification of documents/models stored in the memory 206 corresponding to a case associated to the identified. In some implementations, similarity can be measured using a suitable distance metric, such a cosine similarity or Euclidean distance, computed in the embedding space. The systems can have a configuration parameter to set a threshold based on which two items are to be considered “similar.” If the memory 206 does not include a similar path (that corresponds to) the query, the search returns an empty set. In some implementations, threat modeling execution can terminate in response to failing to identify a similar path in the memory 206.

The path similarity search engine 212 can transmit the optimized or the pruned path with the corresponding threats and mitigations extracted from the similar path to the prompt generation engine 214 for processing. The prompt generation engine 214 can generate, using the vector descriptions and a prompt template, a prompt for the prediction engine 218. For example, for each query that results in a non-empty set of triples (path, threat, mitigation), a prompt having a particular format defined by the prompt template is generated. The results of the vector query can be provided as examples. The number of examples can be a configuration parameter of the system. In some implementations, the prompt, generated by the prompt generation engine 214, can be prefixed, by the threat and mitigation generator 216, with a textual content of documents from previous threat modeling analyses, to include a context in the prompt. The context can include example threats and mitigations, applicable to the paths included in the prompt. For example, the prompt can include a request to generate threats TS_{Th} and mitigations TS_{M} for the optimized or the pruned path TS_{Pi} of the TS_{DFM}.

The threat and mitigation generator 216 can transmit the prompt including the context to the prediction engine 218. The prediction engine 218 can use a prediction model to process the prompt and to produce textual descriptions of threats and mitigations associated with the path corresponding to the prompt and send them to the threat and mitigation generator 216. The prediction engine 218 can include a prediction model, such as LLMs (e.g., deep learning models) trainable on vast quantities of unlabeled data. The LLMs can include GPT 35 TURBO, GPT 35 TURBO-16K, GPT-4, or GPT-4-32K. The prediction engine 218 can be further optimized by efficient training of the adjusted weights of the prediction model. The training of the prediction model can include adjustment of weights to learn threat modeling, e.g., based on paths that are subject to particular threats that can be mitigated using particular mitigations and are within particular contexts. The LLMs can have billions or trillions of weights to update each training iteration. By relying on finetuning the weights of a pretrained base language processing network to generate the threat modeling, the system can drastically reduce the computational resources required to train the adjusted weights. In particular, the system can use a low-rank approximation, or prompt tuning, to generate the adjusted weights for the prediction models. The LLMs include a form of a generative AI having an ability to process textual prompts and additional input data (e.g., context data). The LLMs can be utilized in threat modeling, being configured to learn intricate path patterns and to possess semantic understanding for tasks related to natural language processing. The prediction engine 218 can be stateless such that no data or sessions are stored unless a storage in memory feature is enabled.

The threat and mitigation generator 216 can transmit the prompt and the prompt results to the threat modeling draft generator 220 to generate a threat modeling draft report 222 that can be indexed, by the indexing engine 204, and stored in the memory 206.

The example system architecture 200 includes an innovative generation of attack vectors and threat modeling that employs a robust prediction engine 218 to identify diverse threats and mitigations of a software system. The example system architecture 200 provides an efficient identification of possible threats and reasons of possible threats occurrence and respective mitigations, to increase a security of a software system based on the context associated with a threat. The prompt generation engine 214 feeds the relevant portion of the paths, threats, and mitigations to the prediction engine 218 (e.g., LLM) to compose a seamless security solution. The LLMs can be selected, as a prediction model, to minimize response times. The LLMs can be selected to maximize service output by avoiding LLMs with data processing (e.g., service rate) limit. The LLMs can be selected to increase system security through path similarity matching. The example system architecture 200 provides threat modeling for streamlined identification of threats and mitigation plans applicable to a large variety of software systems.

FIG. 3A is a block diagram of an example data flow model 300A of an example system, according to some implementations of the present disclosure. The example data flow model 300A can be generated by a data flow modeling system (e.g., data flow modeling system 208, described with reference to FIG. 2). The example data flow model 300A illustrates the operations between nodes (components) of a system. The nodes can include user devices 302 (e.g., user devices 104 described with reference to FIG. 1), libraries 304, web pages on disk 306, college library website 308, college library databases 310, and database files 312.

The example data flow model 300A can illustrate the boundary 314 between the user devices 302 and a web server including the web pages on disk 306 and the college library website 308. The boundary 314 between the user devices 302 and a web server (e.g., server system 102, described with reference to FIG. 1) represents the communication channel between user devices 302 and the web server. The communication channel between the user devices 302 and the web server can include internet protocols (HTTP/HTTPS) to securely transmit data. The user devices 302 can send requests 318 over a network to the web server. The web server processes the requests 318, which may include accessing libraries 304, interacting with college library website 308, or querying a college library database 310. Responses 320 from the web server can be sent back to the user devices 302.

The example data flow model 300A can also illustrate the boundary 316 between the web server and a database system including college library databases 310 and database files 312. The boundary 316 represents a communication channel between the web server and the college library database 310. The communication channel defining the boundary 316 server can include connection protocols (e.g., SQL, NoSQL) to query 322 and update database files 312 stored by the college library database 310. The web server sends queries 322 to the college library database 310 and receives data in response 324. The web server can generate requests 326 as external calls to libraries 304 to perform particular functions (e.g., authentication, data processing). Libraries 304 can execute the required functions and return results, as responses 328, to the web server. The web server can interact with external websites (e.g., APIs, third-party services) to fetch or send data, such as pages. For example, the web server can send requests to the websites and can process the received responses. The example data flow model 300A of the example system helps visualize the flow of data and the interactions between different components in a system, defining the boundaries and the operations involving the nodes of the system.

FIG. 3B is a block diagram of an example data flow model 300B including tokens 330-346, according to some implementations of the present disclosure. The example data flow model 300B illustrates tokens 330-346 displayed as annotations to define nodes and the operations between different components. Within the context example system, the tokens 330-346 can include a list as following:
t₁ 330: Users—Request[User device/Web Server Boundary 314]—College Library Website 308
t₂ 332: College Library Website 308—Responses [User device/Web Server Boundary 314]—Users
t₃ 334: Librarians—Request[User device/Web Server Boundary 314]—College Library Website 308
t₄ 336: College Library Website 308—Responses [User device/Web Server Boundary 314]—Librarians
t₅ 338: Web Pages On Disk 306—Pages—College Library Website 308
t₆ 340: College Library Website 308—SQL Query Calls [Web Server/Database Boundary 316]—College Library Database 310
t₇ 342: College Library Database 310—Data [Web Server/Database Boundary 316]—College Library Website 308
t₈ 344: College Library Database 310—Data—Database Files 312
t₉ 346: Database Files 312—Data—College Library Database 310

Within the context example system, the example data flow model 300B can include multiple paths combining the illustrated tokens 330-346 as following:
path₁=t₁, t₆
path₂=t₇, t₂
path₃=t₉, t₈
path₄=t₃, t₄
path₅=t₅

The paths can be processed, by a path optimization system, to generate multiple (e.g., 5) queries, one query for each obtained path. For illustration purposes, it can be assumed that no query returned any similar path vectors, except for the query related to path₁ including tokens t₁, t₆. Assuming that the search returns a single triple: (path₁*, threat₁*, mitigation₁*) where path₁* is a path that is similar to path₁ (Users—Request[User device/Web Server Boundary 314]—College Library Website 308—SQL Query Calls [Web Server/Database Boundary 314]—College Library Database 310). The differences between the similar paths can be identified.
path₁*=Users—Request[User device/Web Server Boundary 314]—Shopping Site Frontend—SQL Query Calls [Web Server/Database Boundary 316]—Database
threat₁*=“A malicious user can inject an SQL query in the frontend of the system”
mitigation₁*=“Apply query sanitization before user-supplied input reaches the database.”

One or more relevant documents can be retrieved from the memory, from which text that constitutes the preamble of the prompt can be extracted. The rest of the prompt can be instantiated using a prompt template and including the path with the identified differences to request from the prediction engine to provide an output including a description of threats and mitigations and you will refer to the particular elements of the paths provide in the question.

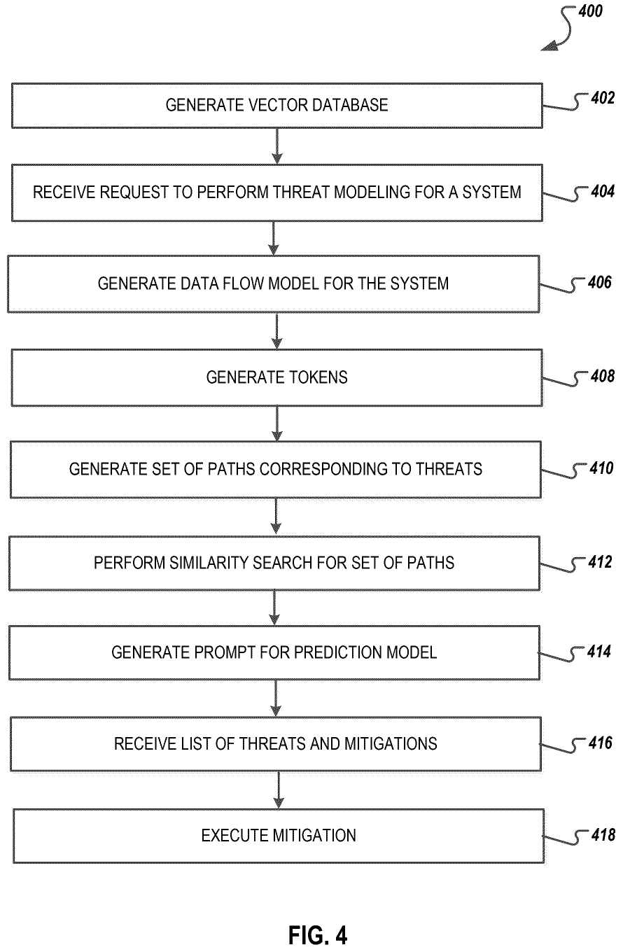

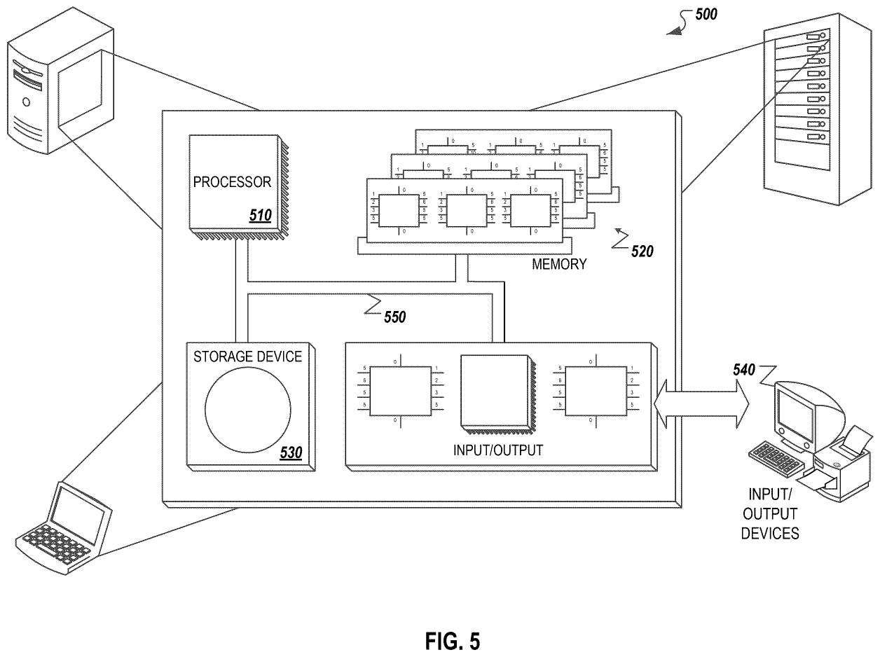

FIG. 4 is a flowchart of an example process 400 for generation of attack vectors and threat modeling, according to some implementations of the present disclosure. The example process 400 can be performed by any component of the example system 100, described with reference to FIG. 1 or the example system architecture 200, described with reference to FIG. 2 or the example computing system 500, described with reference to FIG. 5. For clarity of presentation, the description that follows generally describes the example process 400 in the context of the systems described with reference to FIGS. 1, 2, and 5 and in the context of data flow models, such as described with reference to FIGS. 3A and 3B.

At 402, a vector database is developed during the preliminary phase of threat modeling implementations. The vector database (e.g., memory 112A, 206 described with reference to FIGS. 1 and 2) can include known threats, risks, and vulnerabilities grouped as vectors. The known threats, risks, and vulnerabilities can be extracted from past reports of threat modeling analysis. During vector extraction, for each threat listed in the threat modeling document, the path included in the data flow model that is impacted by the threat is determined. A vector for the identified path is generated and stored. The vector can be stored together with the corresponding textual descriptions of threats and mitigations.

At 404, a request to perform threat modeling for a system is received, by a processor of a user device or by a processor of a server system. The system can be a software system. The system can include one or more subsystems. Each of the one or more subsystems can include nodes that are system or subsystem components that can perform operations including communications with other system components. A communication boundary can be defined for marking communication between node sets distributed between different subsystems of the system. The request can be formatted using natural language and can include one or more textual requirements. The textual requirements of the request can define one or more systems (e.g., a target system) and an action to be performed relative to the identified systems indicative of a request for threat modeling.

At 406, a data flow model corresponding to the system is generated, by the processor. The data flow model can be a diagram or a machine-readable counterpart of a diagram (e.g., example data flow model 300A, as shown in FIG. 3A) representing the nodes and the connections (edges) between the nodes, and sections on threats and mitigations (e.g., textual descriptions).

At 408, a set of tokens is generated, by the processor. The tokens include pairs of connected nodes and the edges defining the connection between the nodes. The one or more edges define operations between the nodes of the respective pair of nodes.

At 410, a set of paths is generated, by the processor. Each path is a fragment of the data flow model including one or more tokens. The tokens of the extracted fragments can be concatenated according to a set of rules. The rules can limit the selection and usage of each token to at most once for a particular path. The rules can limit the tokens of a single path to be connected through a single chain of nodes without creating multiple chains of connected tokens. Each path in the set of paths corresponds to a threat applicable to a plurality of nodes within the path. In some implementations, the generation of the set of paths is reduced-by-construction, as described with reference to FIG. 2. In some implementations, the generated set of paths is pruned (reduced) to remove a portion of the set of paths and maintain a reduced (smaller subset) of paths, according to one or more selection strategies, such as removal of sub-paths, removal of paths in the set of paths that are shorter than a threshold path length, and limiting a path length according to a set path length threshold.

At 412, a similarity search for the obtained set of paths is performed, by the processor. For each obtained path, the vector database can be queried to perform a similarity search and to identify similar paths. In some implementations, similarity can be measured using a suitable distance metric, such a cosine similarity or Euclidean distance, computed in the embedding space. The systems can have a configuration parameter to set a threshold based on which two paths are determined to be at least partially similar. The similarity search results can include a similar path satisfying the similarity criteria applied to one of the paths of the obtained set of paths. The similar path can include one or more differences (e.g., one or more different nodes and/or one or more different edges). The similarity search results can include known threats and known mitigations corresponding to similar paths. For each similar path, the results can include a set of triples (path, threat, mitigation).

At 414, a prompt is generated, by the processor for a prediction model. The prompt can be generated as a text, using the vector descriptions and a prompt template. For example, for each similarity search query that results in a non-empty set of triples (path, threat, mitigation), a prompt having a particular format defined by the prompt template is generated. The known threats and known mitigation can be included in the prompt as context examples that are known to exclude the potential threats corresponding to the difference between the obtained path and the similar path. In some implementations, the prompt includes as a prefix a textual content of documents from previous threat modeling analyses. to include a context in the prompt. The prompt can include a request to generate threats and mitigations for the obtained path according to the provided context. In some implementations, the prompt is validated, by the processor, by processing the one or more textual requirements. Validation of the prompt by processing the one or more textual requirements includes a verification of path and context requirements according to fields of the prompt template. The validation can be executed according to one or more conditions defining a minimum number of textual requirements to be included to enable processing of the request, such as inclusion in the request of at least one path defining nodes of a system, definition of edges between the nodes, context inclusion, at least one action, and inclusion of a request for threats and mitigation. In some implementations, in response to determining that the prompt is missing at least one textual requirement, an alert is displayed by a graphical user interface of the user device requesting the missing textual requirement. The request for the missing textual requirement can include an example of an acceptable type of textual requirement.

At 416, a list of threats and a mitigation plan is received from the prediction model, in response to processing the prompt. The prediction model can include an artificial intelligence model, such as LLMs (e.g., deep learning models) trained using mitigated threats mapped to node settings. The prediction model can be trained, including an adjustment of weights according to different system types or path types, for threat modeling. The prediction model can facilitate threat analysis for intricate path patterns. The list of threats and the mitigation plan can be received as textual content and graphical content. The graphical content can include a representation of the data flow model corresponding to the analyzed system and annotated threats and mitigations (e.g., an annotated data flow model as shown in FIG. 3B). The graphical content can be displayed by a GUI of a user device. In some examples, the graphical representation can be provided as a web-based rendering using a web rendering runtime that is built into the popover container (e.g., iframe). In some examples, the graphical representation is compatible with a UI framework of the popover container. The mitigation plan can be provided as a set of recommendations or instructions for changes in the system design.

At 418, a mitigation plan is executed, by the processor. The mitigation plan can include a modification of a setting of a node of the system (e.g., activation of a firewall) and/or an adjustment of data flow according to a secure sequence of data transmission between the system nodes to perform actions involving the analyzed path. The data flow can be defined by templates indicating which components can be added. The templates can correspond to particular security communication scenarios. An application invoking a sequence of the adjusted data flow can be executed. The execution of the data flow can include retrieval of one or more APIs in the sequence of APIs from a database. The execution of the application can include generating a new API to be included in the sequence of APIs. The execution of the application can include generating an artifact matching the sequence of APIs. The execution of the application can include code generation for connection to the selected APIs to generate the data flow. The output of the automatically embed API calls in source code can be displayed by a graphical user interface.

The example process 400 for generation of attack vectors and threat modeling provides an advantage of contextualizing the LLM with relevant known threats and mitigations, which enhances the accuracy of the identification of relevant threats and mitigation plans for systems with similar paths. The described example process 400 integrates a deeper understanding of historical vectors including paths, threats, and mitigations, enabling LLMs to tailor responses and generate optimized threat and mitigation identification based on training. The example process 400 is applicable to multiple internal and external system types and/or versions to provide a thorough assessment of path relevance for the requested threat modeling.

FIG. 5 is a block diagram of an example computing system 500 used to provide computational functionalities associated with described algorithms, methods, functions, processes, flows, and procedures, according to some implementations of the present disclosure. As shown in FIG. 5, the computing system 500 can include a processor 510, a memory 520, a storage device 530, and input/output devices 540. The processor 510, the memory 520, the storage device 530, and the input/output devices 540 can be interconnected using a system bus 550. The processor 510 is capable of processing instructions for execution within the computing system 500. Such executed instructions can implement one or more components of, for example, the threat modeling system 108, described with reference to FIG. 1. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided using the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a LAN, a WAN, the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 540. The user interface can be generated and presented to a user by the computing system 500 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.
Example 1. A computer-implemented method, comprising: receiving a request to perform threat modeling for a software system comprising nodes performing operations vulnerable to threats; generating tokens that comprise pairs of nodes and one or more edges, wherein the one or more edges define operations between nodes of the pairs of nodes; generating, using the tokens, a set of paths, wherein each path in the set of paths corresponds to a known threat applicable to a portion of the nodes of a respective path; performing a similarity search for the set of paths, to determine a similar path to one path of the set of path, the one path comprising at least a difference from the similar path, the similar path corresponding to known threats and known mitigations; generating, using the one path, the known threats, and the known mitigations, a prompt for a prediction model; and receiving, from the prediction model, a list of threats and a mitigation plan to modify the software system to mitigate the threats.
Example 2. The computer-implemented method of the preceding example, wherein the prediction model comprises a trained large language model.
Example 3. The computer-implemented method of any of the preceding examples, wherein the trained large language model is trained using a plurality of mitigated threats mapped to node settings.
Example 4. The computer-implemented method of any of the preceding examples, wherein generating, using the tokens, a set of paths, comprises: reducing the set of paths to remove a portion of the set of paths; and generating a reduced set of paths.
Example 5. The computer-implemented method of any of the preceding examples, wherein reducing the set of paths to remove a portion of the set of paths, comprises: removal of sub-paths; removal of paths in the set of paths that are shorter than a threshold path length; and limiting a path length.
Example 6. The computer-implemented method of any of the preceding examples, wherein generating, using the tokens, a set of paths, comprises: within each path of the set of paths, selecting each token at most once; and determining that all tokens of each path of the set of paths are connected.
Example 7. The computer-implemented method of any of the preceding examples, wherein generating, using the set of paths, a prompt for a prediction model, comprises: retrieving a prompt template prefixed with a textual content of documents.
Example 8. The computer-implemented method of any of the preceding examples, comprising: generating a graphical representation of the list of threats and mitigations.
Example 9. A computer-implemented system comprising: a computing device; and a computer-readable storage device coupled to the computing device and having instructions stored thereon which, when executed by the computing device, cause the computing device to perform operations for selectively generating graphical representations with digital assistants in enterprise systems, the operations comprising: receiving a request to perform threat modeling for a software system comprising nodes performing operations vulnerable to threats; generating tokens that comprise pairs of nodes and one or more edges, wherein the one or more edges define operations between nodes of the pairs of nodes; generating, using the tokens, a set of paths, wherein each path in the set of paths corresponds to a known threat applicable to a portion of the nodes of a respective path; performing a similarity search for the set of paths, to determine a similar path to one path of the set of path, the one path comprising at least a difference from the similar path, the similar path corresponding to known threats and known mitigations; generating, using the one path, the known threats, and the known mitigations, a prompt for a prediction model; and receiving, from the prediction model, a list of threats and a mitigation plan to modify the software system to mitigate the threats.
Example 10. The computer-implemented system of the preceding example, wherein the prediction model comprises a trained large language model.
Example 11. The computer-implemented system of any of the preceding examples, wherein the trained large language model is trained using a plurality of mitigated threats mapped to node settings.
Example 12. The computer-implemented system of any of the preceding examples, wherein generating, using the tokens, a set of paths, comprises: reducing the set of paths to remove a portion of the set of paths; and generating a reduced set of paths.
Example 13. The computer-implemented system of any of the preceding examples, wherein reducing the set of paths to remove a portion of the set of paths, comprises: removal of sub-paths; removal of paths in the set of paths that are shorter than a threshold path length; and limiting a path length.
Example 14. The computer-implemented system of any of the preceding examples, wherein generating, using the tokens, a set of paths, comprises: within each path of the set of paths, selecting each token at most once; and determining that all tokens of each path of the set of paths are connected.
Example 15. The computer-implemented system of any of the preceding examples, wherein generating, using the set of paths, a prompt for a prediction model, comprises: retrieving a prompt template prefixed with a textual content of documents.
Example 16. The computer-implemented system of any of the preceding examples, the operations comprising: generating a graphical representation of the list of threats and mitigations.
Example 17. A non-transitory computer-readable media encoded with a computer program, the computer program comprising instructions that when executed by one or more computers cause the one or more computers to perform operations comprising: receiving a request to perform threat modeling for a software system comprising nodes performing operations vulnerable to threats; generating tokens that comprise pairs of nodes and one or more edges, wherein the one or more edges define operations between nodes of the pairs of nodes; generating, using the tokens, a set of paths, wherein each path in the set of paths corresponds to a known threat applicable to a portion of the nodes of a respective path; performing a similarity search for the set of paths, to determine a similar path to one path of the set of path, the one path comprising at least a difference from the similar path, the similar path corresponding to known threats and known mitigations; generating, using the one path, the known threats, and the known mitigations, a prompt for a prediction model; and receiving, from the prediction model, a list of threats and a mitigation plan to modify the software system to mitigate the threats.
Example 18. The non-transitory computer-readable media of the preceding example, wherein the prediction model comprises a trained large language model.
Example 19. The non-transitory computer-readable media of any of the preceding examples, wherein the trained large language model is trained using a plurality of mitigated threats mapped to node settings.
Example 20. The non-transitory computer-readable media of any of the preceding examples, wherein generating, using the tokens, a set of paths, comprises: removal of sub-paths; removal of paths in the set of paths that are shorter than a threshold path length; limiting a path length for reducing the set of paths to remove a portion of the set of paths; and generating a reduced set of paths.

What is claimed is:

1. A computer-implemented method, comprising:
receiving a request to perform threat modeling for a software system comprising nodes performing operations vulnerable to threats;
generating tokens that comprise pairs of nodes and one or more edges, wherein the one or more edges define operations between nodes of the pairs of nodes;
generating, using the tokens, a set of paths, wherein each path in the set of paths corresponds to a known threat applicable to a portion of the nodes of a respective path;
performing a similarity search for the set of paths, to determine a similar path to one path of the set of path, the one path comprising at least a difference from the similar path, the similar path corresponding to known threats and known mitigations;
generating, using the one path, the known threats, and the known mitigations, a prompt for a prediction model; and
receiving, from the prediction model, a list of threats and a mitigation plan to modify the software system to mitigate the threats.

2. The computer-implemented method of claim 1, wherein the prediction model comprises a trained large language model.

3. The computer-implemented method of claim 2, wherein the trained large language model is trained using a plurality of mitigated threats mapped to node settings.

4. The computer-implemented method of claim 1, wherein generating, using the tokens, a set of paths, comprises:
reducing the set of paths to remove a portion of the set of paths; and
generating a reduced set of paths.

5. The computer-implemented method of claim 4, wherein reducing the set of paths to remove a portion of the set of paths, comprises:
removal of sub-paths;
removal of paths in the set of paths that are shorter than a threshold path length; and
limiting a path length.

6. The computer-implemented method of claim 1, wherein generating, using the tokens, a set of paths, comprises:
within each path of the set of paths, selecting each token at most once; and
determining that all tokens of each path of the set of paths are connected.

7. The computer-implemented method of claim 1, wherein generating, using the set of paths, a prompt for a prediction model, comprises:
retrieving a prompt template prefixed with a textual content of documents.

8. The computer-implemented method of claim 1, comprising:
generating a graphical representation of the list of threats and mitigations.

9. A computer-implemented system comprising:
a computing device; and
a computer-readable storage device coupled to the computing device and having instructions stored thereon which, when executed by the computing device, cause the computing device to perform operations for selectively generating graphical representations with digital assistants in enterprise systems, the operations comprising:
receiving a request to perform threat modeling for a software system comprising nodes performing operations vulnerable to threats;
generating tokens that comprise pairs of nodes and one or more edges, wherein the one or more edges define operations between nodes of the pairs of nodes;
generating, using the tokens, a set of paths, wherein each path in the set of paths corresponds to a known threat applicable to a portion of the nodes of a respective path;
performing a similarity search for the set of paths, to determine a similar path to one path of the set of path, the one path comprising at least a difference from the similar path, the similar path corresponding to known threats and known mitigations;
generating, using the one path, the known threats, and the known mitigations, a prompt for a prediction model; and
receiving, from the prediction model, a list of threats and a mitigation plan to modify the software system to mitigate the threats.

10. The computer-implemented system of claim 9, wherein the prediction model comprises a trained large language model.

11. The computer-implemented system of claim 10, wherein the trained large language model is trained using a plurality of mitigated threats mapped to node settings.

12. The computer-implemented system of claim 9, wherein generating, using the tokens, a set of paths, comprises:
reducing the set of paths to remove a portion of the set of paths; and
generating a reduced set of paths.

13. The computer-implemented system of claim 12, wherein reducing the set of paths to remove a portion of the set of paths, comprises:
removal of sub-paths;
removal of paths in the set of paths that are shorter than a threshold path length; and
limiting a path length.

14. The computer-implemented system of claim 9, wherein generating, using the tokens, a set of paths, comprises:
within each path of the set of paths, selecting each token at most once; and
determining that all tokens of each path of the set of paths are connected.

15. The computer-implemented system of claim 9, wherein generating, using the set of paths, a prompt for a prediction model, comprises:
retrieving a prompt template prefixed with a textual content of documents.

16. The computer-implemented system of claim 9, the operations comprising:
generating a graphical representation of the list of threats and mitigations.

17. A non-transitory computer-readable media encoded with a computer program, the computer program comprising instructions that when executed by one or more computers cause the one or more computers to perform operations comprising:
receiving a request to perform threat modeling for a software system comprising nodes performing operations vulnerable to threats;
generating tokens that comprise pairs of nodes and one or more edges, wherein the one or more edges define operations between nodes of the pairs of nodes;
generating, using the tokens, a set of paths, wherein each path in the set of paths corresponds to a known threat applicable to a portion of the nodes of a respective path;
performing a similarity search for the set of paths, to determine a similar path to one path of the set of path, the one path comprising at least a difference from the similar path, the similar path corresponding to known threats and known mitigations;
generating, using the one path, the known threats, and the known mitigations, a prompt for a prediction model; and
receiving, from the prediction model, a list of threats and a mitigation plan to modify the software system to mitigate the threats.

18. The non-transitory computer-readable media of claim 17, wherein the prediction model comprises a trained large language model.

19. The non-transitory computer-readable media of claim 18, wherein the trained large language model is trained using a plurality of mitigated threats mapped to node settings.

20. The non-transitory computer-readable media of claim 17, wherein generating, using the tokens, a set of paths, comprises:
removal of sub-paths;
removal of paths in the set of paths that are shorter than a threshold path length;
limiting a path length for reducing the set of paths to remove a portion of the set of paths; and
generating a reduced set of paths.
